(19) United States
(12) Patent Application Publication
(10) Pub. No.: US 2006/0014119 A1
(43) Pub. Date: Jan. 19, 2006

(54) Powered surgical instrument

(76) Inventor: Anthony B. Bouneff, Gaston, OR (US)

Correspondence Address: KOLISCH HARTWELL, P.C., 200 PACIFIC BUILDING, 520 SW YAMHILL STREET, PORTLAND, OR, 97204, US

(21) Appl. No.: 10/890,711

(22) Filed: Jul. 13, 2004

(51) Int. Cl. A61C 3/03

(52) U.S. Cl. 433/118

(57) ABSTRACT

A powered surgical instrument is provided. In some embodiments, the powered surgical instrument includes a housing having a proximal end and a distal end, wherein the distal end is configured to receive an expander adapted to expand the tooth socket. The instrument further may include a user-adjustable actuator disposed within the housing configured to move the expander from a first position to a second position, where the second position is linearly offset from the first position.

### BACKGROUND

A tooth may need to be extracted from the mouth for a variety of reasons. For example, in some situations it may be desirable to extract a tooth that is decayed, damaged or loose. Other times, teeth may be extracted for ‘orthodontic’ reasons, such as to provide room for other teeth, enable other teeth to grow, etc.

In its most basic form, a tooth includes a crown, which is the upper, visible portion of the tooth, and a root structure, which is hidden from view in the boney substructure of alveolar bone comprising the socket. A tooth is secured in place by a combination of factors, including the structural relationship between the root structure and the alveolar bone of the gums and the periodontal ligaments connecting the tooth root structure to the alveolar bone.

Depending on the type of extraction, removal of a tooth may require the skills of dentists, oral surgeons or similar professionals. As used herein, such professionals are referred to as dental professionals. It should be appreciated that the term dental professional should be read broadly to include any individual trained or skilled to extract teeth from a human or animal.

When a tooth includes a sufficient amount of sturdy crown to enable a dental professional to grip the tooth, the tooth may be removed by rocking the tooth until it is released from the socket. The rocking motion accomplishes at least two purposes. First, the rocking motion expands the alveolar bone in the region circumscribing the tooth socket. This rocking motion changes the structural relationship between the tooth root structure and the alveolar bone. Prior to rocking the tooth, the root structure and the alveolus are associated such that the alveolar bone provides a substantial amount of the retentive force on the tooth. The rocking motion compresses the alveolar bone surrounding the root structure, expanding the tooth socket away from the root structure.

Additionally, the rocking motion stretches the periodontal ligaments that extend from the root structure to the alveolar bone. The stretching of the ligaments may break some or all of the periodontal ligaments from the bone. In other cases, the periodontal ligaments may be stretched, but still intact, after completing the rocking motion to expand the tooth socket. In these cases, the dental professional may be able to break the tooth free from the ligaments by pulling on the tooth.

While the rocking technique allows a dental professional to remove a tooth, the procedure is not ideal. The procedure typically requires the dental professional to exert a great deal of force on the tooth to compress the alveolar bone. Additionally, the limited space in the mouth in which the dental professional must complete this rocking technique complicates the procedure. Furthermore, in some circumstances, the rocking motion can be applied with too much force damaging the crown of the tooth before the socket is sufficiently expanded or resulting in damage or breaks in the alveolar bone. If the crown is sufficiently damaged, the tooth may need to be treated as a surgical extraction to accomplish the removal. A surgical extraction traditionally required the removal of bone utilizing a rotary instrument or chisel. Further, broken alveolar bone may complicate the installation of a dental implant immediately after extraction, sometimes requiring bone grafts and subsequent implant placement at a later date.

The rocking procedure briefly described above may be difficult to perform when there is little or no crown for the dental professional to grip. For example, in some patients, the crown may be sufficiently deteriorated, or not sufficiently extended above the alveolar bone to enable a dental professional to grip the crown. In these cases, specialized tools may be used to remove bone to allow gripping of the remaining tooth structure. For example, a drill may be used to drill into the alveolar bone in the space surrounding the tooth being removed to expose more of the tooth. Drilling the bone may result in undesired bone removal. In some cases, the drilled out bone material must then be replaced with graft material and the patient must wait for the damaged alveolar bone to heal. For example, when a patient is to receive a dental implant, the patient may have to return after the tooth socket has healed to receive the implant. The pain and potential complications associated with the bone graft procedure and the delay in installation of the implant may be undesirable for both the patient and the dental professional.

Some dental professionals use manual periotomes during extraction of a tooth. Manual periotomes may be configured with a shaped tip disposed at an end of a shaft. In use, the tip may be placed at the base of the crown adjacent the periodontal ligament space. The dental professional then applies force on the shaft to force the tip into the periodontal space. A great amount of force may be required to use the manual periotome and the dental professional's hand and arm may be fatigued by the process.

As described above, a variety of special tools and techniques have been developed to improve tooth extraction. Such tools may be specialized for single purpose use. For example, in a tooth extraction and implantation procedure, separate instruments may be required to extract the tooth, collect the bone graft material, prepare the implant site and install the implant. This variety of tools may require the dental professional to be familiar with and own multiple different instruments. More than just inconvenient, the use of several different instruments may be expensive for the dental professional.

### SUMMARY

A powered surgical instrument is provided. In some embodiments, the powered surgical instrument includes a housing having a proximal end and a distal end, wherein the distal end is configured to receive an expander adapted to expand the tooth socket. The instrument further may include a user-adjustable actuator disposed within the housing configured to move the expander from a first position to a second position, where the second position is linearly offset from the first position.

### BRIEF DESCRIPTION OF THE DRAWINGS

FIG. 1 is a perspective view of an embodiment of a powered surgical instrument of the present disclosure.

FIG. 2 is a cross-sectional view along line 2-2 schematically illustrating some components of the embodiment shown in FIG. 1.

FIG. 3 is a perspective view of another embodiment of a powered surgical instrument of the present disclosure.

FIG. 4 is a cross-sectional view along line 4-4 schematically illustrating some components of the embodiment shown in FIG. 3.

FIG. 5 is a perspective view of another embodiment of a powered surgical instrument of the present disclosure.

FIG. 6 is a schematic view of a surgical instrument according to another aspect of the present disclosure.

FIG. 7 is a cross-sectional view of the expander in FIG. 5.

FIG. 8 is a schematic illustration of a dental implant site preparation device according to an embodiment of the disclosure.

FIG. 9 is a cross-sectional view of an alternative dental implant site preparation device that may be used in cooperation with a powered surgical instrument of the present disclosure.

FIG. 10 is a perspective view of another dental implant site preparation device that may be used in cooperation with a powered surgical instrument of the present disclosure.

FIG. 11 is a perspective view of one embodiment of a powered surgical instrument of the present disclosure.

FIG. 12 is a cross-sectional view of the embodiment shown in FIG. 11.

### DETAILED DESCRIPTION

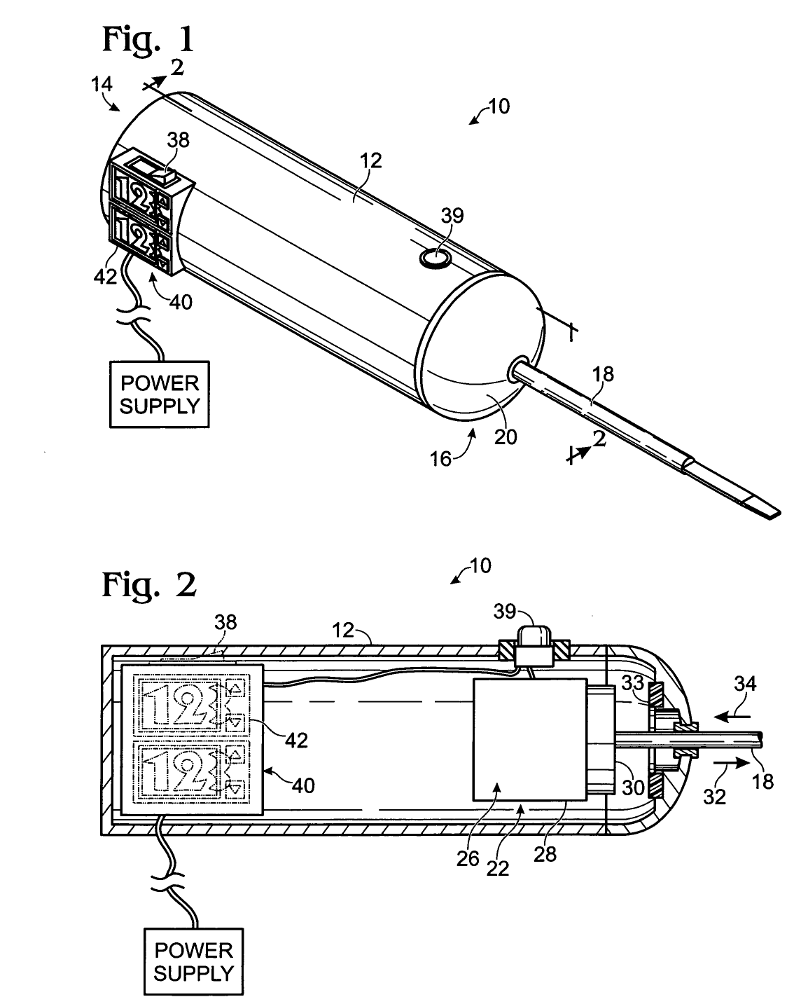

FIG. 1 illustrates, somewhat schematically, a perspective view of a powered surgical instrument according to one embodiment of the present disclosure. It should be appreciated that the powered surgical instrument described below may be used in any suitable dental or medical application, including, for example, extraction of teeth and dental implant procedures. Further, such powered surgical instrument may be used in both human medical and dental applications as well as veterinary medical and dental applications.

It should be noted that the drawings depict a plurality of embodiments for the powered surgical instrument and that reference characters may refer to corresponding elements throughout multiple views. Similarly, the drawings are intended to illustrate exemplary embodiments that depict a variety of elements and subelements. It is within the scope of the disclosure that these elements and subelements may be selectively embodied in devices according to the present invention alone or in combination with one or more other elements and/or subelements, regardless of whether the particular selected element, subelement, or combination thereof is specifically illustrated in the figures. For example, the powered surgical instrument disclosed herein may include any of the described and/or illustrated actuation controls, actuators, power supplies, tips, etc., regardless of the particular combination shown in a specific figure.

As shown in FIG. 1, powered surgical instrument 10 may include a housing 12. Housing 12 may be configured as a cylindrical body as shown or it may have other suitable configurations. It should be noted that a portion of housing 12 may be contoured to be comfortably held in the hand of a dental professional. For example, the housing may be ergonomically designed to substantially correspond to a user's grip. Additionally, housing 12 may be provided with gripping features or padding to increase the dental professional's comfort and ability to grip the housing. Although not described in detail herein, it should be recognized that housing 12 may include additional features to increase its functionality or its cooperation with other dental instruments and apparatus, such as holders, chargers, power supplies, etc.

Housing 12 may include a proximal end 14 and a distal end 16. Distal end 16 may be configured to receive an expander 18. In some embodiments, distal end 16 may be configured to selectively receive one of a plurality of tools configured to perform one or more surgical functions. Expander 18, as well as, the plurality of selectively receivable tools will be described in more detail below.

Powered surgical instrument 10 may also include a receiver 20 within housing 12 adapted to selectively receive an expander. In some embodiments, receiver 20 may be adapted to receive one or more of a variety of tools of different dimensions and configurations. A locking mechanism may be incorporated in distal end 16 of housing 12 or into receiver 20 to accommodate receipt and securement of the various tools to the instrument. For example, and not by limitation, housing 12 or receiver 20 may include a locking mechanism similar to the adjustable chuck customarily used on power drills in the hardware industry. Additionally, distal end 16 or receiver 20 may include other clamping mechanisms that will be recognized as suitable for securing differently-sized tools.

With reference to FIG. 2, powered surgical instrument 10 may include an actuator 22 disposed within housing 12. As used herein, the term “actuator” includes a device that causes movement in another component of the surgical instrument, such as expander 18 or other tool secured by receiver 20 or distal end 16. The movement caused by the actuator may be linear in one direction or it may be linear in a reciprocating, back and forth motion. When actuator 22 causes reciprocating movement, actuator 22 may be referred to as a “reciprocator.” It should be understood that powered surgical instrument 10 may include an actuator 22 configured to move expander 18 in a forward linear motion, such as from a first position to a second position offset from the first position, such as indicated by forward directional arrow 32 in FIG. 2. Alternatively, actuator 22 may be adapted to move expander 18 in a reverse linear motion, such as indicated by reverse directional arrow 34. Thus, the expander may be driven away from the housing 12, toward housing 12 or in both directions. In some embodiments, actuator 22 may be configured to allow a user to select the direction of linear motion, forward 32, reverse 34 or both. In other embodiments, actuator 22 may be configured to alternatingly move expander 22 in both the forward direction and the reverse direction.

Actuator 22 may be any suitable linear driving device. For example, actuator 22 may be a solenoid actuator, a pneumatic actuator, a mechanical actuator, or other actuator capable of causing linear motion. FIG. 2 illustrates a solenoid actuator 26, which may include a solenoid coil 28 and a plunger 30 configured to slidingly engage the coil. In an exemplary embodiment, solenoid actuator 26 may be configured to move plunger 30 in the forward direction, shown by arrow 32, and allow the force of the dental professional pushing instrument 10 to move plunger 30 in the reverse direction, shown by arrow 34. Alternatively, solenoid actuator 26 may be adapted to move plunger 30 in the reverse direction or in reciprocating forward and reverse directions.

Solenoid actuator 26 may be configured to reciprocatingly move plunger 30 in the forward direction 32 and the reverse direction 34. Such a configuration may be achieved by using a biasing member to drive the plunger in the reverse direction. Any suitable biasing mechanism may be used, including, but not limited to, a spring, a bumper, such as a gasket, a reversal of the polarity of the solenoid coil, or by other means. In the embodiment illustrated in FIG. 2, a rubber gasket 33 is illustrated forward of plunger 30. Rubber gasket 33 may be configured to rebound plunger 30 in the reverse direction preparing it for subsequent movement in the forward direction by actuator 22.

In some embodiments, a bi-directional solenoid may be incorporated within the housing. The bi-directional solenoid may decrease the fatigue experienced by a dental professional and may allow for increased functionality of the instrument. In an embodiment of surgical instrument 10 where the solenoid is bi-directional, solenoid actuator 26 may be operatively coupled to expander 18 such that the reverse motion of plunger 30 also pulls expander 18 in the reverse direction 34.

Actuator 22 may be configured to linearly drive expander 18 to enable a dental professional to more easily remove a tooth or perform other surgical functions. For example, expander 18 may be configured to be positioned along the periodontal ligament space. In some embodiments, expander 18 may be sized such that it is slightly larger than the periodontal ligament space.

As the actuator moves expander 18 linearly, the alveolar bone surrounding the tooth socket is compressed or compacted, thus expanding the socket along the periodontal ligament space. Expander 18 is thus adapted to expand the tooth socket. The linear driving motion of the powered surgical instrument operates with sufficient force to compress the bone surrounding the tooth socket. As a byproduct of the compression of the bone surrounding the tooth socket, the periodontal ligaments may be severed or otherwise broken. Once the bone is sufficiently compressed and the socket is sufficiently expanded, the tooth may be gripped and removed. The linear motion of the powered surgical instrument facilitates the expansion of the tooth socket while minimizing the fatigue which would occur if such a procedure was attempted manually.

With reference to FIGS. 1 and 2, surgical instrument 10 may also include a power supply. The power supply may be external to housing 12, such as an electrical connection between surgical instrument 10 and a standard alternating circuit power supply. Alternatively, the power supply may be disposed within housing 12. In such an embodiment, the power supply may include batteries, either rechargeable or non-rechargeable.

Surgical instrument 10 may also include a power control 38. Regardless of how power is supplied to surgical instrument 10, power control 38 may be configured to allow the dental professional to turn the instrument on or off. Surgical instrument 10 may be considered to be “on” when power is flowing from power supply 36 to another component of powered surgical instrument 10, such as actuator 22. Power control 38 may be disposed on housing 12 as shown in FIGS. 1 and 2. Alternatively, power control 38 may be disposed external to housing 12, such as on an external control box or other component.

Surgical instrument 10 may also include an actuation or reciprocation control 40. Actuation control 40 may be disposed on or within housing 12 or it may be external to housing 12, such as on an external control box, as will be seen in other embodiments described below. It should be understood that actuation control 40 is in communication with actuator 22. Actuation control 40 may be configured to enable a user, such as the dental professional, to selectively adjust one or more properties of the actuator or other operational element of the surgical instrument 10.

Actuation control 40 may include a variety of user interfaces and controls, including analog systems and/or digital systems. Actuation control 40 may be a mechanical controller and/or an electronic controller. For example, in FIGS. 1 and 2, surgical instrument 10 is shown with an electronic controller 42. Electronic controller 42 may include one or more LED displays (or other type of electronic display), one or more user input devices, such as touch pads, sliders, or dials, and one or more digital processors to convert the user input into electronic signals.

It should be appreciated that actuation control 40 may include other control systems, including, but not limited to, analog systems incorporating dials and electrical circuitry rather than digital processing, combinations of analog and digital systems, etc. For example, actuation control 40 may include a combination of digital and analog systems working cooperatively to enable a user to selectively control or adjust the linear motion as generated by actuator 22. Examples of these and other alternative embodiments will be better understood with reference to the description below.

Actuation control 40, in whatever embodiment it is implemented, may be configured to adjust the linear motion induced by actuator 22. For example, actuation control 40 may control one or more of the following characteristics or other like characteristic: the frequency of the linear motion, the intensity of the linear motion, the stroke-length of the linear motion, or some other characteristic of the motion. With continued reference to the embodiment shown in FIG. 1, it should be understood that expander 18 will move at a given speed (frequency), will travel a certain distance in each direction with each motion (stroke-length), and will travel with a certain force conveyed by actuator 22 (intensity). Other characteristics that may be controlled by actuation control 40 may include such things as modifying one or more of these characteristics over time to create actuation or reciprocation patterns. As one example of an actuation pattern, a user may prefer a lower frequency, intensity, or stroke-length at the beginning of the procedure to ensure proper placement of the instrument and prefer a higher frequency, intensity, or stroke-length after the expansion is underway and the expander is at least partially maintained in the proper placement by the surrounding tooth and bone.

As an illustration of the use of actuation control 40 to enable a user to selectively control characteristics of the motion generated by actuator 22, the following examples are provided.

In some embodiments, actuation control 40 may allow a user to select the frequency at which actuator 22 drives expander 18. In some embodiments, the range of selectable frequencies may range from about 0 Hz to about 40.0 kHz, or anywhere there between. In some embodiments, the upper frequency limit may be 20 kHz, 10 kHz, or 1.0 kHz. Embodiments with a narrower range of selectable frequencies may also be configured. For example, in some embodiments, the selectable range of frequencies may span from about 0 Hz to about 100 Hz. In still other embodiments, the selectable range may span from about 0 Hz to about 60 Hz. Actuation control 40 may be configured to allow a user to select a desired frequency in the range. Alternatively, actuation control 40 may be indexed so that a user can select from a collection of predetermined frequencies within the range.

Additionally, actuation control 40 may allow a user to select the intensity at which actuator 22 drives expander 18. In some embodiments, the actuator may drive the expander with up to about 1.5 pounds of force. A user may be able to select an intensity ranging from 0 pounds-force to about 1.5 pounds-force. Alternatively, actuation control 40 may provide an index of selectable intensities within this range. In other embodiments, actuator 22 may drive expander 18 with a lower maximum force, such as 0.75 pounds-force or 1.0 pounds-force.

In some embodiments, actuation control 40 may enable a user to select the stroke-length that actuator 22 provides expander 18. As described above, in the embodiments where a solenoid actuator is used, actuation control 40 may adjust the stroke-length by modifying the extent to which plunger 30 is driven in the forward direction (represented by arrow 32), by modifying the amount of rebound force provided by a biasing force, or by adjusting the position of the solenoid actuator 26 within housing 12. In some embodiments, the user may be able to select a stroke-length ranging from about 0.01 mm to about 1.0 mm or anywhere there between. In other embodiments, the stroke-length may be selectable within a range from about 0.01 mm to about 0.5 mm.

Referring back to the figures, in some embodiments, housing 12 may be configured with an operational control 39. Operational control 39 may be disposed on housing 12 to provide additional control and convenience to the dental professional performing the surgical procedure. For example, operational control may be configured to temporarily halt the motion of expander 18 without requiring the dental professional to modify other settings or reach for other controls. The operational control may be configured to cooperate with a portion of actuator 22 or with a portion of expander 18 or both. It should be appreciated that in some embodiments, operational control 39 may cooperate with power control 38 or with actuation control 40. Although shown at the distal end 16 of housing 12, operational control 39 may be disposed on any suitable location on the housing of the instrument or accessible component of the instrument.

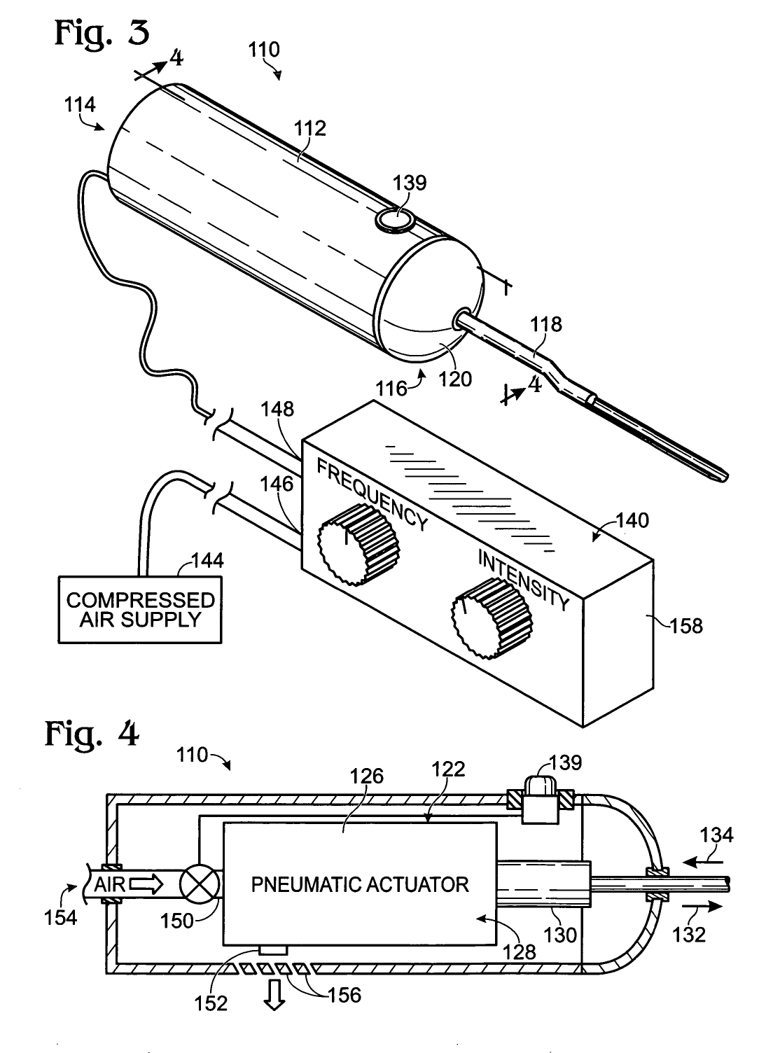

Referring now to FIGS. 3 and 4, an alternative embodiment of a powered surgical instrument is illustrated in a somewhat schematic perspective view. As described above, components of this embodiment may be interchangeable with the earlier and later described embodiments and are not limited to the combinations as illustrated in the exemplary figures.

As in FIGS. 1 and 2, the powered surgical instrument 110 of FIGS. 3 and 4 includes a housing 112 with a proximal end 114 and a distal end 116. Distal end 116 may be configured to receive an expander 118. Surgical instrument 110 may also include a receiver 120 as described above. It will be noticed in FIG. 3 that expander 118 has a slightly different configuration than expander 18 of FIG. 1. The differences will be discussed in greater detail below.

The embodiment shown in FIGS. 3 and 4 also includes an actuator 122 to move expander 118. Like in the embodiment shown in FIGS. 1 and 2, actuator 122 may be configured to move expander 118 in a linear motion. However, actuator 122 of the embodiment illustrated in FIGS. 3 and 4 is a pneumatic actuator 126 as opposed to solenoid actuator 26 of FIGS. 1 and 2. Pneumatic actuator 126 may include one or more pneumatic devices, represented schematically at 128, capable of pneumatically moving plunger 130 to move expander 118 in a linear motion. As with solenoid actuator 26, pneumatic actuator 126 may be configured to drive plunger 130 in the forward direction, shown by arrow 132, in the reverse direction, shown by arrow 134, or in both the forward and the reverse directions, either selectively or alternatingly.

Surgical instrument 110 incorporating pneumatic actuator 126 may also include a compressed air supply 144 in communication with pneumatic actuator 126. Compressed air supply 144 may supply a stream of compressed air to an actuation control 140. For example, as shown in FIG. 3, actuation control 140 may have an air input 146 and an air output 148. Alternatively, compressed air supply 144 may provide compressed air directly to housing 112 and pneumatic actuator 126. In some embodiments, pneumatic actuator 126 or actuation control 140 may be configured with a plurality of valves, channels, and other components adapted to allow a user to selectively control the linear motion provided by the actuator, such as forward only, reverse only, or reciprocating motion.

Air from compressed air supply 144 may be directed into instrument 110. For example, as shown in FIG. 4, pneumatic actuator 126 may include a housing air inlet 154, an air feed 150 and an air vent 152. Housing 112 may also include an air vent 156. In some embodiments, actuation control 140 will control the air supply to pneumatic actuator 126 to cause plunger 130 to drive expander 118 in a linear motion. Alternatively, a steady stream of compressed air may be provided to pneumatic actuator 126 and the pneumatic actuator may control the movement of plunger 130.

As shown in FIG. 3, actuation control 140 may include one or more controls to allow a user to selectively adjust the linear motion as described above. For example, in the illustrated embodiments, actuation control 140 may include user-maneuverable dials that may be selectively adjusted during a procedure. Similar to the embodiments shown in FIGS. 1 and 2, actuation control 140 may be used to selectively control the frequency of actuation, the intensity of actuation, or the stroke-length, as well as other characteristics. Actuation control 140 may be part of a separate control box 158 or, in some embodiments, one or more of the controls may be disposed on housing 112. Additionally, compressed air supply 144 may be a separate component as shown in FIG. 3 or it may be incorporated into control box 158.

When powered surgical instrument 110 is pneumatically driven as in FIGS. 3 and 4, the power supply and power control may be different than the power supply and power control described in connection with the embodiment illustrated in FIGS. 1 and 2. For example, there may be several power controls that cooperate to determine when pneumatic actuator 126 actually moves or drives expander 118. For example, in some embodiments, there may be a power control on compressed air supply 144; a power control on control box 158; a power control associated with actuation control 140; a power control on housing 112; a power control associated with pneumatic actuator 126; a power control associated with more than one of these components, etc. One or more power controls may cooperate to control when actuator 122 moves expander 118 in a linear motion. Additionally, one or more of these power controls may be configured as an operational control 139 (as discussed above in regards to operational control 39) to temporarily secure expander 118 in a fixed location while not interfering with the operation of the remaining components.

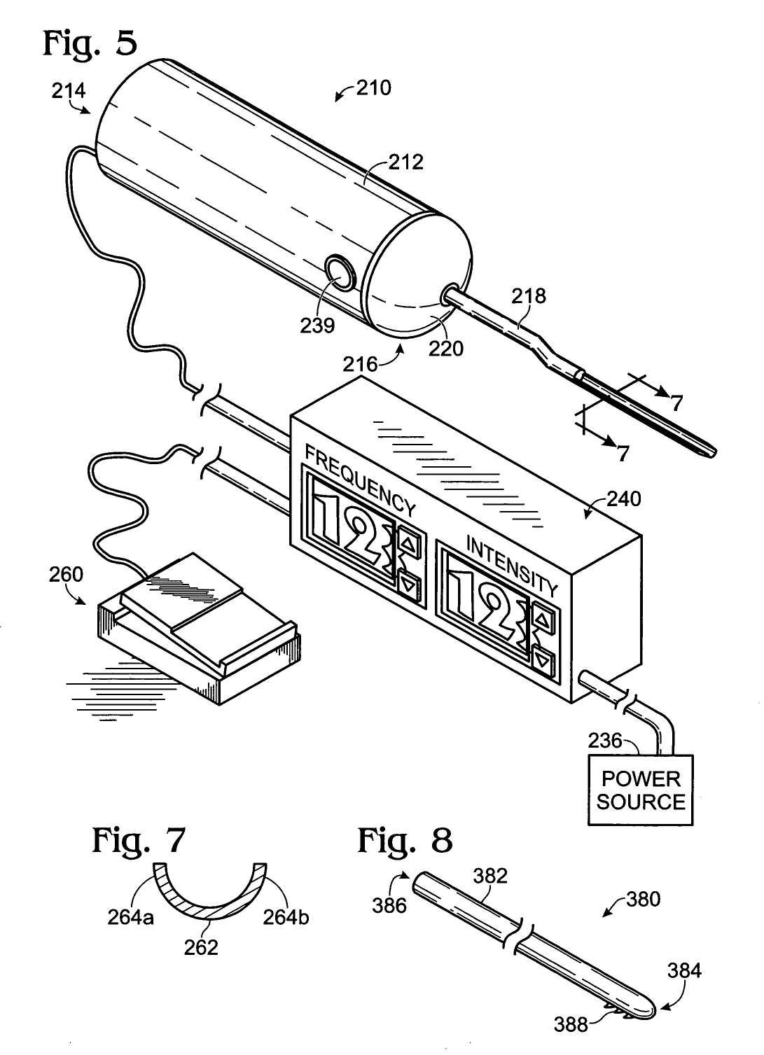

FIG. 5 illustrates another embodiment of the powered surgical instrument of the present disclosure. Powered surgical instrument 210 may include the features discussed above in connection with instrument 10 and/or instrument 110. In FIG. 5, both actuation control 240 and power source 236 are external to housing 210. Further, actuation control 240 is shown as a digital readout, but it should be appreciated that the dials of FIG. 3 or other like controls may be used without departing from the scope of the disclosure.

FIG. 5 further illustrates an embodiment wherein powered surgical instrument 210 includes a pressure sensitive device, such as foot pedal 260. The pressure sensitive device may be a foot pedal as shown, but may also include other pressure sensitive devices, such as a touch pad disposed on housing 212. In some embodiments, foot pedal 260 may cooperate with actuation control 240 to allow a user additional control over the linear motion during the surgery or procedure. In this way, pressure sensitive device 260 is similar to operational control 39, 139. However, in addition to the start/stop functions of operational control 39, foot pedal 260 may be adapted to allow a user to variably control one or more characteristics, such as frequency, intensity, etc.

For example, foot pedal 260 may be configured to allow a user to adjust the frequency of the motion by applying more or less pressure. In some embodiments, powered surgical instrument may be provided with more than one pressure sensitive device, such as a foot pedal and a touch pad. The pressure sensitive device that may be a component of powered surgical instrument 210 may be adapted to cooperate with actuation control 240 to allow adjustment up to set maximum. For example, when foot pedal 260 is used to adjust the frequency of linear motion, actuation control 240 may be adapted to allow a user to set a maximum frequency and foot pedal 260 may be configured to allow the user to vary the frequency between 0 Hz and the maximum frequency set on actuation control 240.

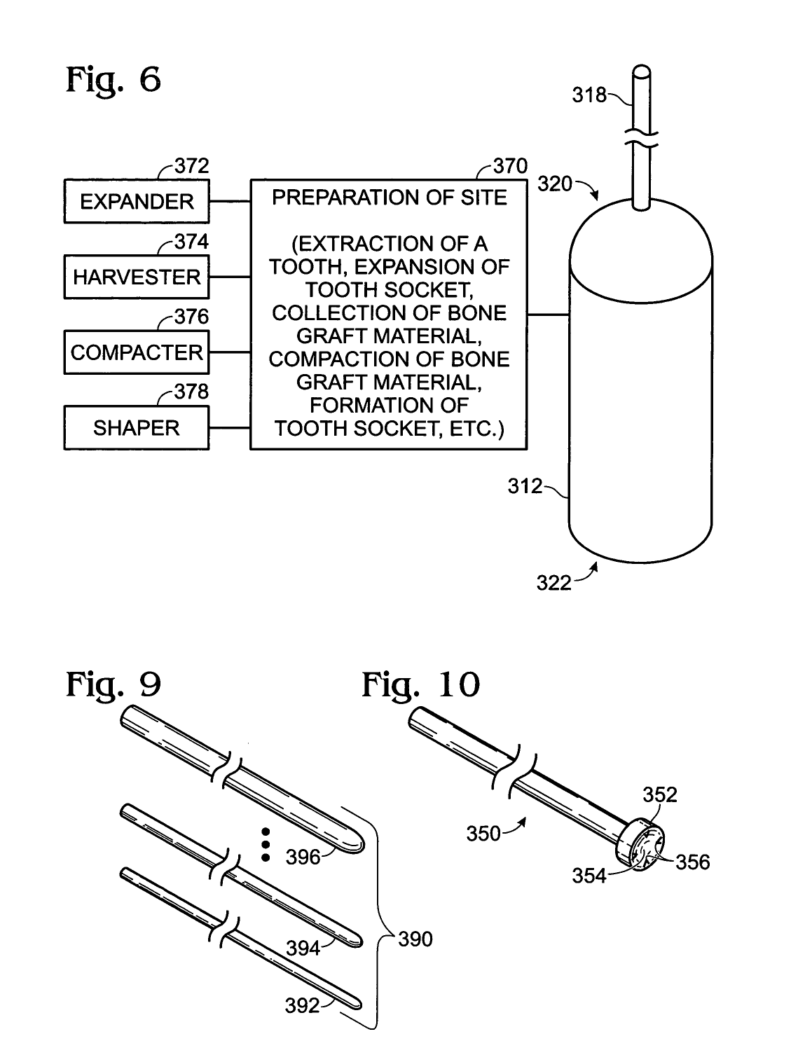

FIGS. 6-10 illustrate an embodiment of powered surgical instrument adapted to prepare a tooth socket for a dental implant. As in the embodiments described above, the surgical instrument of FIG. 6 may include a housing 312. Housing 312 may include a receiver (indicated generally at 320) configured to selectively receive a dental implant site preparation device 318. The actuator (as indicated by general arrow 322) may be any suitable actuator configured to drive the dental implant site preparation device 318 linearly.

FIG. 6 illustrates a dental implant site preparation device 318 somewhat schematically. It should be understood that the expander described above is an example of a dental implant site preparation device 318 and that the above description of surgical instruments, actuators, and expander motion also may describe the surgical instrument of FIG. 6 and dental implant site preparation device 318.

The procedure for installing a dental implant often begins with extraction of the natural tooth to make way for the implant. However, the natural tooth socket is generally not naturally prepared to receive a dental implant. For example, the alveolar bone material around the tooth socket may not be able to securely hold the implant or the tooth socket may not be properly shaped to receive the implant.

Exemplary steps for preparing a dental implant site are summarized in box 370 of FIG. 6. For example, such steps may include, but are not limited to, removing or extracting a resident tooth, expanding the tooth socket, collecting bone graft material, compacting bone graft material into the tooth socket and forming the tooth socket to the proper shape. Additionally, when bone graft material is utilized, the dental professional may treat the placement area to facilitate proper healing. For example, the bone graft placement area may be covered with a protective membrane that is secured to the surrounding bone using bone tacks.

As illustrated in FIG. 6, a powered surgical instrument may be used to prepare a dental implant site by selectively securing a dental implant site preparation device 318 to housing 312. One exemplary dental implant site preparation device may include an osteotome. The osteotome as an implant site preparation device may be used in soft bone to form the site by compressing the bone laterally, causing a denser bone to implant interface, rather than removing valuable bone from the surgical site. A variety of additional site preparation devices may be used in cooperation with the disclosed powered surgical instrument, some of which include an expander 372, a harvester 374, a compacter 376, and a shaper 378. It should be understood that a single site preparation device may be configured to perform more than one function, such as compaction of bone material and shaping of the tooth socket.

Expander 372 may be used to extract the tooth from the tooth socket, as discussed above. For example, expander 372 may be configured to have a width slightly larger than the width of the periodontal ligament space. When expander 372 is slightly larger than the periodontal ligament space, the linear motion of the expander compresses or compacts the alveolar bone surrounding the tooth socket expanding the socket. Additionally, as the socket expands and expander 372 is moved further into the periodontal ligament space, expander 372 may be adapted to cut or sever the periodontal ligaments. Embodiments of expander 372 are illustrated in FIGS. 1, 3, and 5 as expander 18, 118, and 218 respectively. Expander 372 may be adapted to have a relatively flat distal end as shown in FIG. 1.

Alternatively, expander 372 may have a contoured distal end as shown in FIGS. 3 and 5. A cross-section of the contoured distal end is illustrated in FIG. 7, which is a cross-sectional view of expander 218 in FIG. 5. Contoured expander 218 may be adapted to substantially correspond with the contours of an average tooth. Contoured expander 218 may be formed in a u-shaped configuration having a bottom portion 262 and a pair of raised portions 264a, 264b.

Additionally, expander 372 may be configured with a bayonet tip as shown in FIG. 5. It should be understood that some embodiments of the implant site preparation device include one or more bends in the shaft. Such bends in the shaft may be similar to those shown in FIG. 5 or may include other bends and configurations of the shaft to enable the dental professional to better access the surgical site.

It should be understood that expander 372 may include a variety of devices configured to facilitate removal of a tooth and/or preparation of a tooth socket for a dental implant. Expander 372 is adapted to expand the periodontal ligament space and may be configured to have width at the distal end greater than the width of the periodontal ligament space. On average, the periodontal ligament space ranges from 0.25 mm to 0.4 mm. Expanders 372 of the present disclosure may have a width at the distal end ranging from about 0.25 mm to about 0.75 mm.

With continued reference to FIG. 6, the powered surgical tool disclosed herein also may be used with a harvester. Harvester 374 may be used to collect bone fragment material. An exemplary harvester is illustrated in FIG. 8 and includes a shaft 382 having a distal end 384 and a proximal end 386. Harvester 374 may also include one or more scrapers 388 disposed adjacent to distal end 384. In use, harvester 374 may be used to collect bone fragment material by placing scrapers 388 in contact with a surface of a bone

Harvester 374 may be received within the powered surgical instrument described herein such that the harvester is driven in a collection direction (e.g. toward the housing) to coincide with the configuration of scrapers 388. However, harvester 374 may also be used in cooperation with a surgical instrument configured to drive in a forward direction if scrapers 388 were configured accordingly. The driven motion of harvester 374 coinciding with the configuration of scrapers 388 allows the harvester to collect bone graft material with less effort and fatigue for the dental professional.

A compacter 376 may also be received within the disclosed powered surgical tool. Compacter 376 may be configured to perform one or more functions. For example, compacter 376 may be configured to pack bone graft material into a tooth socket. Additionally, compacter 376 may be configured to compress bone material surrounding the tooth socket to increase the density of the bone to implant interface to better receive an implant. As mentioned above, an empty tooth socket is not generally naturally prepared for receipt of an implant. Bone graft material is often used to provide the dental professional with material to form a more preferred implant site. The graft material may be compacted into place, such as by repeated impacts from compacter 376.

A shaper 378 may also be received within powered surgical tool 318. Shaper 378 of FIG. 6 may include a set of site shaping devices 390 illustrated in FIG. 9. A set of site shaping devices 390 may include one or more shapers 392, 394, 396. Each shaper 392, 394, 396 may be configured to perform one or more functions similar to those of compacter 376. For example, site-shaping devices 390 may be configured to pack bone graft material into a tooth socket. Additionally, site-shaping devices may be configured to compress bone material surrounding the tooth socket to densify the bone to implant interface. As shown, the shapers have a rounded distal end but the distal end may be configured to meet particular needs or desires of patients or dental professionals. For example, the shapers may be tapered to form the site into the proper shape for receiving the dental implant. The difference between shaper 378 and compacter 376 will be better understood with reference to the following discussion.

Once the graft material is compacted into the socket or when graft material is not used, it may still be desirable to shape the tooth socket. A natural tooth socket may be oblong or elliptical and many dental implants are circular. Accordingly, dental implant site preparation may include forming the tooth socket to correspond with the dental implant. For example, bone graft material may be compacted into a socket leaving a socket opening that may be smaller than required to receive the implant. A hole the size of the implant may be drilled into the graft material but the edges of the hole may not be dense enough or stable enough to secure an implant.

A compression and expansion process may be used to form the tooth socket for receiving an implant and to increase the density of socket. In such a process, a hole smaller than the diameter of the implant may be drilled to start the forming process. For example, the dental implant may have a diameter of 5.0 millimeters and a 2.0 millimeter hole may be drilled in the filled-in tooth socket. Subsequently, a 3.5 mm diameter shaper 392 may be driven into the 2 mm hole. Each of the shapers 392, 394, 396 may have a tapered distal end to allow the larger compactor to start into the hole prepared by the smaller compacter. The impact of the larger diameter shaper into the hole compresses the bone graft material outwardly, densifying the bone and forming the implant site. Shaper 392 may be driven by powered surgical instrument in a forward direction or in reciprocating motion to reduce the fatigue on the dental professional. Shaper 392 will form a 3.5 mm hole in the filled-in tooth socket. Shaper 394 may then be driven into the filled-in tooth socket by the surgical instrument. Shaper 394 may have a 4.3 mm diameter and may compress the bone enlarging the tooth socket to 4.3 mm in diameter. This process of expanding a hole in the filled-in tooth socket may continue until the hole reaches the desired diameter. For example, shaper 396 may have a diameter of 5.0 mm to prepare a dental implant site for a 5.0 mm diameter implant.

Another dental implant site preparation device 318 is illustrated in FIG. 10. Tack driver 350 may be adapted to drive tacks into bone surrounding a bone-graft placement area. For example, typically, once bone graft material is placed in the implant site from a collection area, the placement area needs to heal. As discussed above, a dental professional may place a protective membrane over the placement area to allow the bone to grow back (rather than being displaced by faster growing soft tissue). The protective membrane may be secured to the bone with bone tacks.

Tack driver 350 may facilitate the securement of the protective material through the repetitive linear motion of the powered surgical instrument disclosed herein. Tack driver 350 may be configured to have a blunt head 352 as shown in FIG. 10. Blunt head 352 may have a flat surface or it may be configured with a slight concavity 354 as illustrated. Blunt head 352 may also be configured with a plurality of flanges 356 within concavity 354. A tack may be positioned within concavity 354 on blunt head 352. Flanges 356 may secure the tack. The powered surgical instrument may then be positioned to drive the tack into place. Once the bone tack is started into the bone, the flanges will release the tack and the actuator will continue to smoothly drive the tack into the bone.

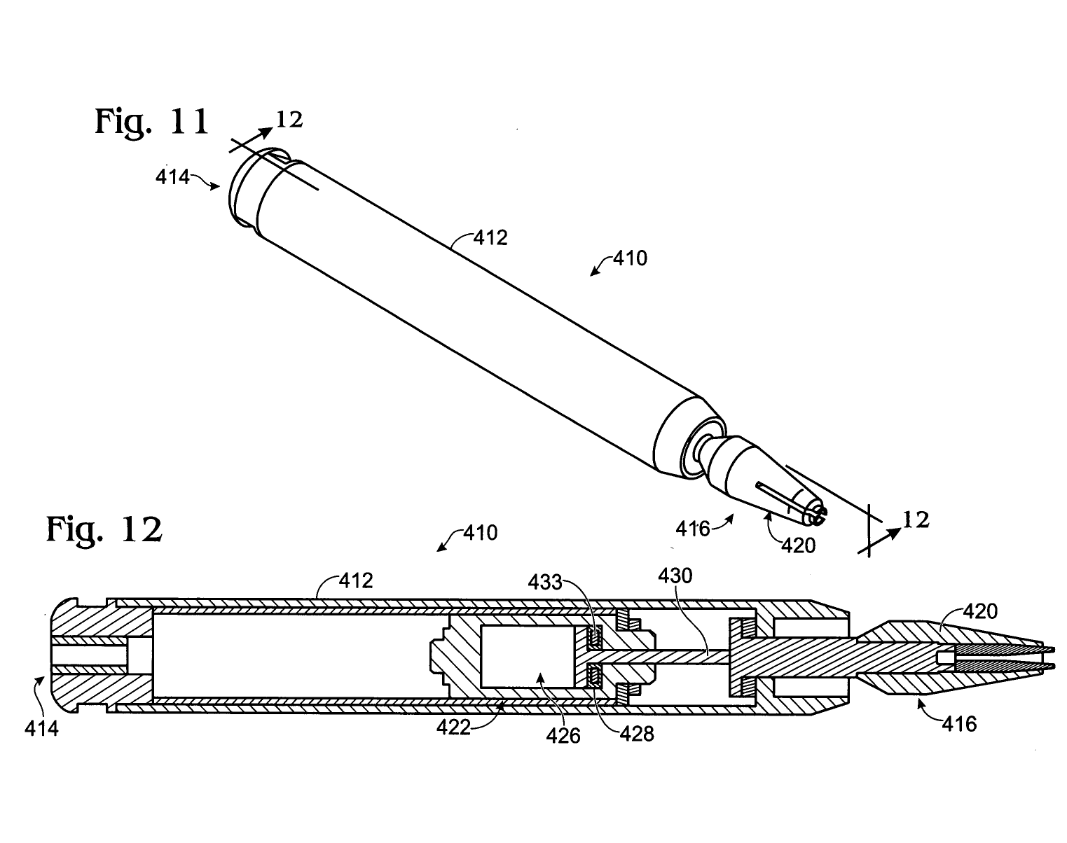

FIGS. 11 and 12 illustrate an alternative embodiment of a powered surgical instrument. It should be understood that the instrument shown in FIGS. 11 and 12 are exemplary only and may be combined with one or more of the features and aspects described above. FIG. 11 illustrates a perspective view of powered surgical instrument 410 according to the present disclosure. As shown in FIG. 11, powered surgical instrument 410 includes a housing 412, a proximal end 414, a distal end 416, and a receiver 420.

FIG. 12 illustrates a cross-sectional view of the embodiment illustrated in FIG. 11. As seen in FIG. 12, powered surgical instrument 410 includes a housing 412, a proximal end 414, a distal end 416, and a receiver 420. Within the housing 412, powered surgical instrument 410 is illustrated as including an actuator 422 operatively associated with receiver 420 to move dental implant site preparation devices that may be received therein. Actuator 422 is illustrated as a solenoid actuator 426, including a solenoid coil 428 and a plunger 430. Additionally, actuator 422 is shown including biasing member 433 to drive the reverse linear motion of plunger 430. In the embodiment of FIG. 12, biasing member 433 includes one or more springs.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment and such features, structures and/or characteristics may be included in various combinations with features, structures and/or characteristics of other embodiments.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A powered surgical instrument comprising:
a housing having a proximal end and a distal end, wherein the distal end is configured to receive an expander adapted to expand a tooth socket; and
a user-adjustable actuator disposed within the housing configured to move the expander from a first position to a second position, where the second position is linearly offset from the first position.

2. The powered surgical instrument of claim 1, wherein the user-adjustable actuator enables a user to selectively adjust intensity.

3. The powered surgical instrument of claim 1, wherein the user-adjustable actuator enables a user to selectively adjust frequency.

4. The powered surgical instrument of claim 1, wherein the user-adjustable actuator enables a user to selectively adjust stroke length.

5. The powered surgical instrument of claim 1, wherein the user-adjustable actuator enables a user to selectively adjust a movement pattern.

6. The powered surgical instrument of claim 1, wherein the distal end is configured to releasably receive an expander.

7. The powered surgical instrument of claim 1, wherein the distal end is configured to selectively receive one of an expander, a harvester, a compacter, and a shaper.

8. The powered surgical instrument of claim 1, wherein the actuator includes a solenoid actuator.

9. The powered surgical instrument of claim 8, wherein the solenoid actuator includes a solenoid coil and a plunger, and wherein the solenoid actuator alternatingly drives the plunger from a plunger first position to a plunger second position and from the plunger second position to the plunger first position.

10. The powered surgical instrument of claim 1, wherein the actuator includes a pneumatic device.

11. The powered surgical instrument of claim 1, wherein the expander is configured to facilitate removal of a tooth.

12. The powered surgical instrument of claim 7, wherein the expander, harvester, compacter, and shaper are configured to prepare the tooth socket to receive a dental implant.

13. A powered surgical instrument comprising:
a housing;
a receiver within the housing, the receiver adapted to receive an expander;
a reciprocator disposed within the housing configured to move the expander in a linear-reciprocating motion; and
a user-adjustable reciprocation control operatively associated with the reciprocator and configured to enable a user to selectively adjust the linear reciprocating motion of the expander.

14. The powered surgical instrument of claim 13, wherein the user-adjustable control enables a user to selectively adjust intensity.

15. The powered surgical instrument of claim 13, wherein the user-adjustable control enables a user to selectively adjust frequency.

16. The powered surgical instrument of claim 15, wherein the user-adjustable control enables a user to selectively adjust frequency within a frequency range from about 0 Hz to about 100 Hz.

17. The powered surgical instrument of claim 13, wherein the user-adjustable control enables a user to selectively adjust stroke length.

18. The powered surgical instrument of claim 17, wherein the user-adjustable control enables a user to selectively adjust stroke-length within a stroke-length range from about 0.01 mm to about 1.0 mm.

19. The powered surgical instrument of claim 18, wherein the user-adjustable control enables a user to selectively adjust stroke-length within a stroke-length range from about 0.01 mm to about 0.5 mm.

20. The powered surgical instrument of claim 13, wherein the user-adjustable control enables a user to selectively adjust a reciprocation pattern.

21. The powered surgical instrument of claim 20, wherein the reciprocation pattern includes an increase in reciprocating motion intensity.

22. The powered surgical instrument of claim 13, wherein the user-adjustable control includes a pressure sensitive device.

23. The powered surgical instrument of claim 13, wherein the receiver is configured to releasably receive an expander.

24. The powered surgical instrument of claim 13, wherein the receiver is configured to selectively receive one of an expander, a harvester, a compacter, and a shaper.

25. The powered surgical instrument of claim 13, wherein the reciprocator includes a solenoid actuator.

26. The powered surgical instrument of claim 25, wherein the solenoid actuator includes a solenoid coil and a plunger, and wherein the solenoid actuator alternatingly drives the plunger from a plunger first position to a plunger second position and from the plunger second position to the plunger first position.

27. The powered surgical instrument of claim 13, wherein the reciprocator includes a pneumatic actuator.

28. The powered surgical instrument of claim 13, wherein the expander is configured to facilitate removal of a tooth.

29. The powered surgical instrument of claim 24, wherein the expander, harvester, compacter, and shaper are configured to prepare the tooth socket to receive a dental implant.

30. A powered surgical instrument comprising:
a housing;
a receiver configured to selectively receive a first dental implant site preparation device and a second dental implant site preparation device; and
a user-adjustable actuator operatively coupled to the receiver to move one of the first dental site preparation device and the second dental site preparation device in a linear motion.

31. The powered surgical instrument of claim 30, wherein the user-adjustable actuator is configured to move one of the first dental site preparation device and the second dental site preparation device in a first direction.

32. The powered surgical instrument of claim 31, wherein the first direction is a forward direction away from the housing.

33. The powered surgical instrument of claim 31, wherein the first direction is a reverse direction toward the housing.

34. The powered surgical instrument of claim 30, wherein the user-adjustable actuator is configured to move one of the first dental site preparation device and the second dental site preparation device in both a first direction and an opposing second direction.

35. The powered surgical instrument of claim 30, further comprising a user-adjustable actuation control.

36. The powered surgical instrument of claim 35, wherein the user-adjustable control enables a user to selectively adjust intensity.

37. The powered surgical instrument of claim 35, wherein the user-adjustable control enables a user to selectively adjust frequency.

38. The powered surgical instrument of claim 37, wherein the user-adjustable control enables a user to selectively adjust frequency within a frequency range from about 0 Hz to about 100 Hz.

39. The powered surgical instrument of claim 35, wherein the user-adjustable control enables a user to selectively adjust stroke length.

40. The powered surgical instrument of claim 39, wherein the user-adjustable control enables a user to selectively adjust stroke-length within a stroke-length range from about 0.01 mm to about 1.0 mm.

41. The powered surgical instrument of claim 40, wherein the user-adjustable control enables a user to selectively adjust stroke-length within a stroke-length range from about 0.01 mm to about 0.5 mm.

42. The powered surgical instrument of claim 35, wherein the user-adjustable control enables a user to selectively adjust an actuation pattern.

43. The powered surgical instrument of claim 42, wherein the actuation pattern includes an increase in actuation intensity.

44. The powered surgical instrument of claim 35, wherein the user-adjustable control includes a pressure sensitive device.

45. The powered surgical instrument of claim 30, wherein the receiver is configured to selectively receive one of a plurality of dental implant site preparation devices.

46. The powered surgical instrument of claim 45, wherein the receiver is configured to selectively receive one of an expander, a harvester, a compacter, and a shaper.

47. The powered surgical instrument of claim 30, wherein the actuator includes a solenoid actuator.

48. The powered surgical instrument of claim 42, wherein the solenoid actuator includes a solenoid coil and a plunger, and wherein the solenoid actuator alternatingly drives the plunger from a plunger first position to a plunger second position and from the plunger second position to the plunger first position.

49. The powered surgical instrument of claim 30, wherein the actuator includes a pneumatic actuator.

50. A powered surgical instrument kit adapted to prepare a tooth socket for a dental implant comprising:
a housing;
a receiver;
an expander adapted to be selectively secured in the receiver;
a harvester adapted to be selectively secured in the receiver;
a compacter adapted to be selectively secured in the receiver;
a shaper adapted to be selectively secured in the receiver; and
an actuator disposed within the housing configured to be operatively associated with the receiver to move one of the expander, the harvester, the compacter, and the shaper in a linear motion.

51. The powered surgical instrument of claim 50, wherein the actuator is user-adjustable.

52. The powered surgical instrument of claim 51, wherein the user-adjustable actuator is configured to move one of the expander, the harvester, the compacter, and the shaper in a first direction.

53. The powered surgical instrument of claim 52, wherein the first direction is a forward direction away from the housing.

54. The powered surgical instrument of claim 52, wherein the first direction is a reverse direction toward the housing.

55. The powered surgical instrument of claim 51, wherein the user-adjustable actuator is configured to move one of the expander, the harvester, and the shaper in both a first direction and an opposing second direction.

56. The powered surgical instrument of claim 50, further comprising a user-adjustable actuation control.

57. The powered surgical instrument of claim 56, wherein the user-adjustable control enables a user to selectively adjust intensity.

58. The powered surgical instrument of claim 56, wherein the user-adjustable control enables a user to selectively adjust frequency.

59. The powered surgical instrument of claim 56, wherein the user-adjustable control enables a user to selectively adjust stroke-length.

60. The powered surgical instrument of claim 56, wherein the user-adjustable control enables a user to selectively adjust an actuation pattern.

61. The powered surgical instrument of claim 50, wherein the actuator includes a solenoid actuator.

62. The powered surgical instrument of claim 61, wherein the solenoid actuator includes a solenoid coil and a plunger, and wherein the solenoid actuator alternatingly drives the plunger from a plunger first position to a plunger second position and from the plunger second position to the plunger first position

63. The powered surgical instrument of claim 50, wherein the actuator includes a pneumatic actuator.

64. The powered surgical instrument of claim 50, wherein the expander is configured to expand the tooth socket.

65. The powered surgical instrument of claim 50, wherein the harvester is configured to collect bone graft material.

66. The powered surgical instrument of claim 50, wherein the compacter is configured to pack bone graft material into the tooth socket.

67. The powered surgical instrument of claim 50, wherein the shaper is configured to form the tooth socket to a predetermined configuration.

68. The powered surgical instrument of claim 50, wherein the expander is configured to facilitate removal of a tooth.

69. The powered surgical instrument of claim 50, wherein the expander, harvester, compacter, and shaper are configured to prepare the tooth socket to receive a dental implant.

70. A powered surgical instrument, comprising:
a housing;
a receiver operatively associated with the housing configured to receive an expander;
a solenoid actuator operatively associated with the expander to move the expander linearly; and
a user-adjustable control operatively associated with the solenoid to enable selective control of the motion of the expander.

71. The powered surgical instrument of claim 70, wherein the receiver is configured to releasably receive the expander.

72. The powered surgical instrument of claim 71, wherein the receiver is configured to selectively receive one of an expander, a harvester, a compacter, and a shaper,

73. The powered surgical instrument of claim 70, wherein the solenoid actuator includes a solenoid coil and a plunger, and wherein the solenoid actuator alternatingly drives the plunger from a plunger first position to a plunger second position and from the plunger second position to the plunger first position.

74. The powered surgical instrument of claim 70, wherein the actuator is user-adjustable.

75. The powered surgical instrument of claim 74, wherein the user-adjustable actuator is configured to move the expander in a first direction.

76. The powered surgical instrument of claim 75, wherein the first direction is a forward direction away from the housing.

77. The powered surgical instrument of claim 75, wherein the first direction is a reverse direction toward the housing.

78. The powered surgical instrument of claim 74, wherein the user-adjustable actuator is configured to move the expander in both a first direction and an opposing second direction.

79. The powered surgical instrument of claim 70, further comprising a user-adjustable actuation control.

80. The powered surgical instrument of claim 79, wherein the user-adjustable control enables a user to selectively adjust intensity.

81. The powered surgical instrument of claim 79, wherein the user-adjustable control enables a user to selectively adjust frequency.

82. The powered surgical instrument of claim 79, wherein the user-adjustable control enables a user to selectively adjust stroke-length.

83. The powered surgical instrument of claim 79, wherein the user-adjustable control enables a user to selectively adjust an actuation pattern.

84. The powered surgical instrument of claim 79, wherein the user-adjustable control includes a pressure sensitive device.

85. The powered surgical instrument of claim 70, wherein the expander is configured to facilitate removal of a tooth.

86. The powered surgical instrument of claim 75, wherein the expander, harvester, compacter, and shaper are configured to prepare the tooth socket to receive a dental implant.
